(19) United States
(12) Patent Application Publication
(10) Pub. No.: US 2008/0170870 A1
(43) Pub. Date: Jul. 17, 2008

(54) IMAGE FORMING APPARATUS

(76) Inventors: Toru YAMAGUCHI, Tokyo (JP); Yasushi Koshimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/951,259

(22) Filed: Dec. 5, 2007

(30) Foreign Application Priority Data
Jan. 11, 2007 (JP) JP2007-003183

(51) Int. Cl. G03G 15/00; G03G 15/043; G03G 15/06

(52) U.S. Cl. 399/49; 399/51; 399/55

(57) ABSTRACT

An image forming apparatus includes: a photoreceptor, a charging unit which charges the photoreceptor; an exposing unit which forms a latent image onto the photoreceptor; a developing unit which develops the latent image to a toner image; a sensor which detects a line width of a toner patch formed on the photoreceptor by the exposing unit and the developing unit; and a controller which changes a background voltage based on the line width detected by the sensor during an image forming operation so that the line width is secured within a predetermined line width. The controller returns the background voltage to value adjacent to an initial setting background voltage and changes the light amount of the exposing unit by a light amount corresponding to a returning amount of the background voltage.

This application is based on Japanese Patent Application No. 2007-003183 filed on Jan. 11, 2007, which is incorporated hereinto by reference

### BACKGROUND OF THE INVENTION

The present invention relates to an image forming apparatus of an electro-photographic system for developing a latent image on a photoreceptor with developer to form a toner image.

In an image forming process of the electro-photographic system, the image density and the line width of an image formed change according to the temperature and humidity of the setting location of the image forming apparatus, the photoreceptor (an image carrier) and a usage time of the developer.

In order to stabilize the image quality of a print image, the image quality and the line width have to be stabilized. With respect to the technologies for stabilizing the line width, there have been provided a method for controlling a background voltage (fogging/blurring voltage: This voltage is defined as the difference between a charged voltage and a developing bias voltage) and a method of controlling an exposure light amount.

Here, the line width will be described as follows.

FIG. 2 illustrates a drawing to describe a surface potential level of a line width (latent image) formed onto a photoreceptor.

In FIG. 2, the latent image of potential level having a line width “d” on the photoreceptor is ideally supposed to be visualized into a toner image shown in a solid line. However, practically, the latent image becomes a potential distribution shown in a dotted line, which is not a line width having an even density distribution.

Here, V0 is a charged potential, V1 is a latent image potential of the line width formed by an exposing unit, Vb is a bias potential (DC component) to be inputted to a developing unit. The background voltage “a” (=V0−Vb) approaches to “0” (zero), the portion of the potential distribution shown in a dotted line whose potential is lower than Vb, which is a line width “d”, becomes wide and a fogged/blurred image occurs due to the weakly charted toner. Reversibly, as the background voltage “a” becomes large, the line width “d” becomes narrow. In case when two-component developer is used, carrier splashing occurs in case when the background “a” voltage becomes larger than a certain value.

Up to now, in order to regulate the changes of the image density and the line width, a feedback method has been taken by setting a higher charged potential and correcting the line width when humidity is low by measuring the temperature and humidity of the environment, and by detecting the line width of the toner image and the image density.

Unexamined Japanese Paten Application Publication No. 06-161195 discloses a method of obtaining a print image corresponding to a user preference by providing an adjustment unit for adjusting a developing bias and an exposure light amount to a photoreceptor so as to independently set the surface image density and the line width of the line image. Unexamined Japanese Paten Application Publication No. 2000-162837 discloses a method of preventing a fogged/blurred image on a non-image area by controlling the difference between the developing bias and the electro static voltage of an electrostatic latent image to become a predetermined range to maintain a predetermined deposited amount and to protect image tailing, and controlling the difference between the developing bias and a discharged surface voltage of the photoreceptor to become a predetermined range to protect the fog to the non-imaging area.

However, in the image writing device adopting a two-component developer and LPH (LED Print Head), the line width cannot be maintained only by controlling the background voltage. Thus, carrier splashing tends to occur. Further, particularly in the high-speed machine, it is difficult to obtain enough resolution by utilizing the method of controlling the emitting time of LPH.

### SUMMARY OF THE INVENTION

It is therefore an object of the present invention is to provide an image forming apparatus, which is capable of maintaining the predetermined line width within a range where the fogged/blurred image and carrier splash do not occur, even if two-component developer is used

An aspect of the present invention is as following.

An image forming apparatus including a photoreceptor, a charging unit which charges the photoreceptor, an exposing unit which forms a latent image onto the photoreceptor, a developing unit which develops the latent image to a toner image, a sensor which detects a line width of a toner patch formed on the photoreceptor, and a controller which changes a background voltage based on the line width detected by the sensor during an image forming operation so that a line width is secured within a predetermined line width, and wherein the controller puts the background voltage back to a value adjacent to an initial setting background voltage and changes the light amount of the exposing unit by a light amount equivalent to a put-back amount of the background voltage.

### BRIEF DESCRIPTION OF THE DRAWINGS

FIG. 1 illustrates a schematic diagram of an example of an image forming apparatus in an embodiment of the present invention.

FIG. 2 illustrates a drawing to describe a surface potential level of a line width (latent image) formed onto a photoreceptor,

FIG. 3 illustrates a sensor for detecting a toner patch PT positioned between images on a photoreceptor.

FIG. 4 illustrates a flowchart of a background voltage correction.

FIGS. 5(a)-5(b) are drawings for explaining a processing method of a background voltage correction and a light emitting amount correction of LPH while the image forming process has stopped.

FIG. 6 illustrates a flowchart of a change in the background voltage or a light emitting amount of LPH at the point when the image forming process has been stopped.

FIG. 7 illustrates a flowchart of an operation process of the entire line width correction, into which the background voltage of every “n” prints and the light amount correction while the image forming process is in a stop state are combined.

FIG. 8 is illustrated to explain the method of executing the background voltage correction and LPH light emitting amount correction in every an image forming process of a predetermined number of sheets.

FIG. 9 illustrates a flowchart of the line width correction process executed in a periodical timing.

### DETAILED DESCRIPTION OF THE PREFERRED EMBODIMENT

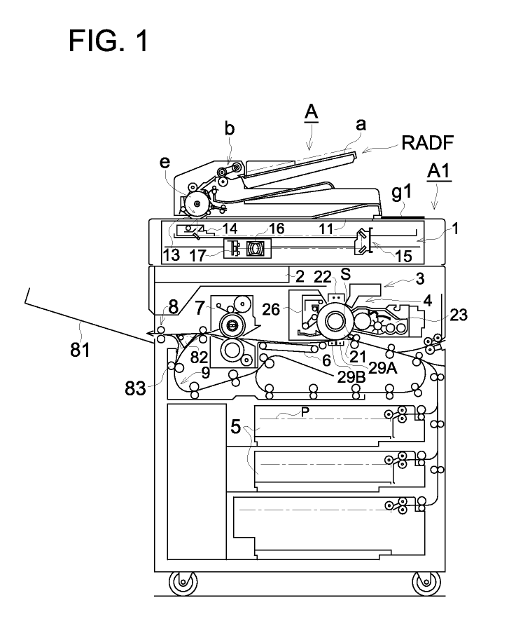

An image forming apparatus of the present invention will be explained based on FIG. 1 hereinafter.

In an explanation of an embodiment in the present invention, a scope of technology of the present invention is not limited to the terms used in this specification.

FIG. 1 illustrates a schematic diagram of an example of an image forming apparatus of the embodiment.

In FIG. 1, an image forming apparatus A, which is an image forming apparatus of the present invention, includes a reversing automatic document feeder RADF and an apparatus main body A1.

The reversing automatic document feeder RADF disposed on the top of the apparatus main body A1 is capable of opening and closing. An original document on a document feed tray “a” is conveyed to a feed roller “b” and a conveyance drum “e” then the original document is conveyed.

The apparatus main body A1 includes an image reading device 1, an image processing section 2 (may be named a controlling section, hereinafter) including a controller, an image writing section 3, an image forming section 4, a sheet feed tray 5, a conveyance unit 6, a fixing unit 7, an ejection unit 8 and a reversing section 9.

An optical system of the image reading apparatus 1 includes a lighting unit 14 including a light source and a first mirror, a V-mirror unit 15 configured by a second mirror and a third mirror, a lens 16 and a CCD image sensor 17. An image reading of an original document by the reversing automatic document feeder RADF is conducted at a position where the lighting unit 14 configured by a light emitting element of LED stops at the first position beneath a slit exposing glass 13. An original document reading on a document table glass 11 is processed while moving the lighting unit 14 and the V-mirror unit 15.

Image information of the original document image, which was read in the image reading apparatus 1, is image-processed by the image processing section 2, and image data is signalized and temporarily stored in a memory. An output light from a LPH included in the image writing section 3, which is an exposure unit, is irradiated onto a photoreceptor 21 and forms an electrostatic latent image.

In the image forming section 4, a surface of the photoreceptor 21 is uniformly charged with electrostatic charge by a charger 22, which is a charging unit. The electrostatic latent image is formed by an irradiation from the LPH of the image writing section 3. Next, the electrostatic latent image becomes a toner image by being developed by a developing section, which is a developing unit 23, onto which a bias voltage is applied. The toner image is transferred onto a sheet P, which had been conveyed from a sheet feeding tray 5, by a transfer unit 29A. The sheet P, onto which the toner image had been transferred, is separated from a photoreceptor surface by a separating unit 291. Then, excess toner on the photoreceptor 21 is removed by a cleaning unit 26. The sheet P, onto which the toner image had been transferred, is conveyed by a conveyance unit 6, fixed by a fixing section 7 and conveyed to an ejection tray 81 provided out of the apparatus by an ejection member 8.

Further, for duplex copying, the sheet P, onto the first side of which an image has been formed, is sent into a reversing section 9 by a conveyance path switching member 82. Then, the sheet P is reversed and conveyed to a sheet ejection tray 81 by the ejection unit 8 after an image has been formed onto the second side of the sheet P in the image forming section again. When executing a reverse sheet ejection, the sheet P branched from a normal ejection path is switched back in a reversed sheet ejection section 83 and reversed. Then, the sheet P is conveyed to the sheet ejection tray 81 by the ejection member 8.

The present invention will be explained hereinafter.

As described above, in an image forming process of an electro-photographic system, a line width of the image quality formed may fluctuate corresponding to an environmental condition, a photoreceptor and a time period of developer use. As a result, the density changes. Therefore, it is important to stabilize the line width to stabilize the image quality.

In case when maintaining the line width only by the background voltage as shown in a prior example, in which one-component developer is used, the carrier splashing occurs in case of the two-component developer. Further, a sufficient resolution in the line width control is hard to be obtained with a method to control the exposure light amount with the LPH light emitting time of the writing device especially with a high-speed machine.

The following embodiment for the present invention is characterized that while in the (continuous) image forming process, the line width of a toner patch formed on the photoreceptor is detected, background voltage and LPH light emitting time are changed to maintain the line width constant and thereby to prevent an occurrence of a fogged/blurred image and the carrier splashing.

FIG. 3 illustrates a sensor for detecting a toner patch between images on the photoreceptor.

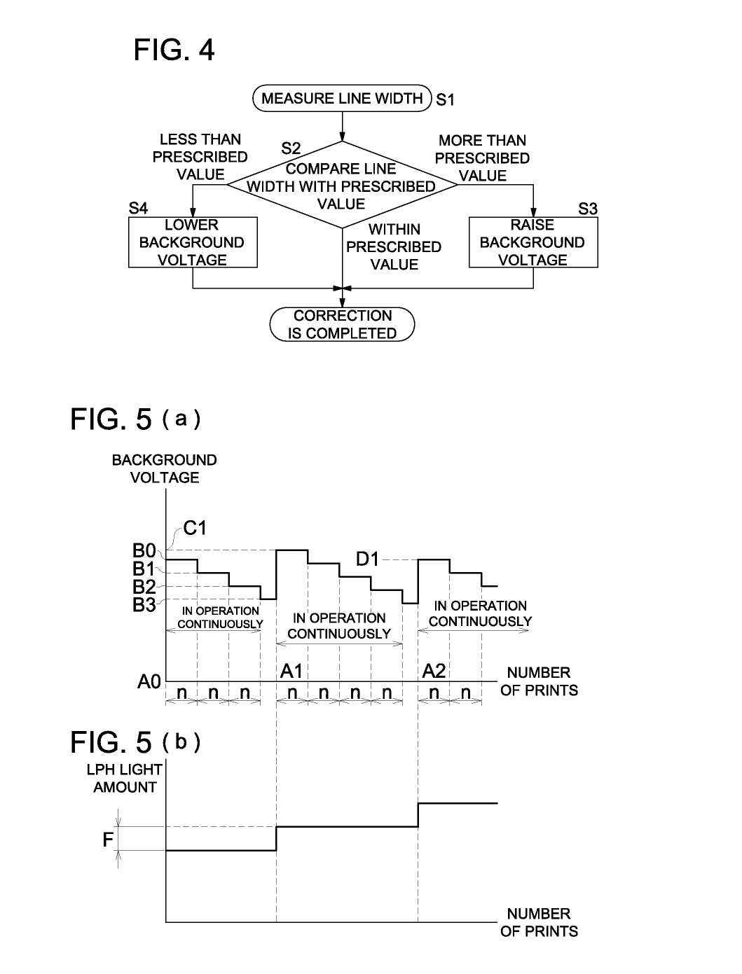

FIG. 4 illustrates a flowchart of a background voltage correction.

FIGS. 5(a) and 5(b) are illustrated to explain a method to proceed with the background voltage correction and LPH light emitting amount correction while the image forming process has stopped.

In FIG. 3 and FIG. 5(a), a toner patch PT (patterned images), which is a sensor for the line width, is formed on a space positioned between images (a space positioned between papers) P from the beginning of the print A0 to every n prints (where n=10 in the embodiment) on the photoreceptor while the image forming is in process. An image sensor S, which is a sensor, detects this toner patch PT. The output value of the sensor S is converted into the line width in the controlling section. When assuming the initial background voltage set as B0 at the image formation start A0, the background voltage at the time of n prints is corrected to B1, and similarly, the background voltage is corrected to B2 at the time of 2n prints, and the background voltage is corrected B3 at the time of 3n prints.

To explain this process with the flowchart in FIG. 4, in STEP S1, the image sensor S, which is a sensor section, detects the line width of the toner patch, and transmits the output to the controlling section. When the outputted value of the line width of the toner patch detected in STEP S2 is off from a prescribed value corresponding to a predetermined line width, namely, when it is more than the range of the prescribed value, since the line width widens, the background voltage is raised in STEP S3. When it is less than the prescribed value, since the line width narrows, the background voltage is moved to be lower in STEP S4. The correction method is taken to control the each output value to be in the range of the prescribed value.

Further, the fluctuation amount of the output value of the image sensor S responding to the line width of the toner patch and the fluctuation amount of the background voltage is programmed in the controlling section, for example, as displayed in the table of table 1.

However, there are some fears that the control range cannot be secured when the line width is corrected only with the background voltage.

Accordingly, it is possible to maintain a stable image by returning the background voltage, which has been changed in every number “n” print, to the adjacent the initial setting background voltage B0 at the time of A1 when an image formation operation stops (while stopping) and correcting the emitting amount of the LPH by an emitting amount equivalent to the returning amount so as to secure the predetermined line width. In FIGS. 5(a) and 5(b), it is possible to maintain stable image quality by controlling the line width within a predetermined range, when the image formation operation stops (while stopping), by raising the LPH emitting amount by “F”, which corresponds to the correction amount of the background voltage from B0 to B3, and returning the background voltage to “c1”, which is adjacent to the initial background voltage B0.

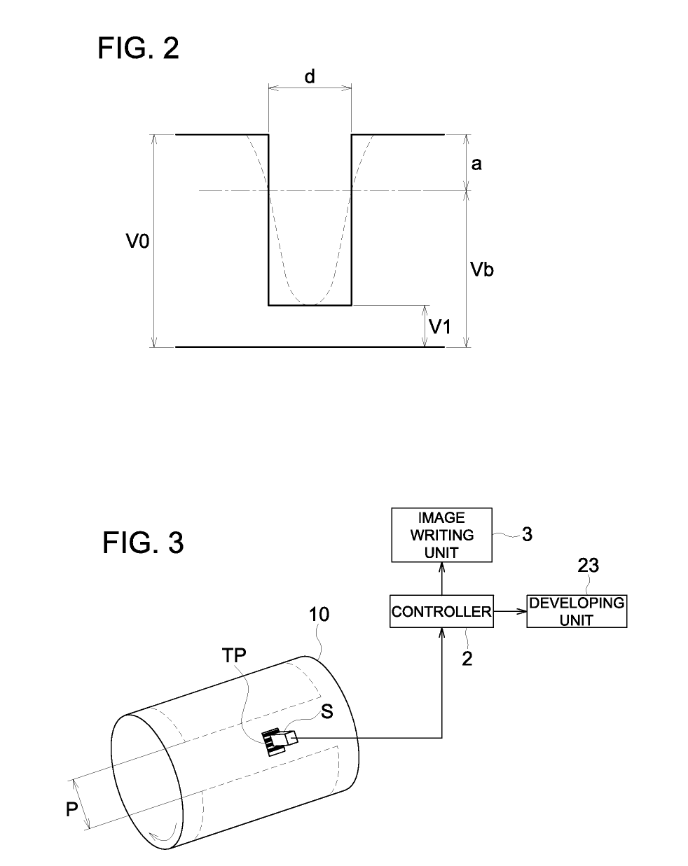

Namely, the output value of LPH is to be changed and controlled to put back the background voltage “a” (shown in FIG. 2), which has been changed with a predetermined interval, to adjacent the initial setting value.

Further, the relationship between the output of the toner patch and line width and the background voltage changing amount corresponding to the LPH emitting output changing amount is programmed in the controlling section as a table, for example, as shown in the Table 1.

TABLE 1

| Semiconductor laser | | | | | | | |
|---|---|---|---|---|---|---|---|
| output value | −3 step | −2 step | −1 step | 0 | +1 step | +2 step | +3 step |
| Image sensor output | −0.36 V | −0.24 V | −0.12 V | 0 | +0.12 V | +0.24 V | +0.36 V |
| Equivalent background | +25 V | +16 V | +8 V | 0 | −8 V | −16 V | −25 V |
| voltage | | | | | | | |

The Table 1 illustrates each fluctuation amount of the background voltage and the light emitting amount, which are equivalent to a fluctuation amount of the line width (image sensor output).

In Table 1, 1 step means a time period of light emitting (an exposure) of LPH, and it is equivalent to 14 μsec in the embodiment. For example, when an output value (a light amount) of LPH is increased by +2 step (28 μsec), a line width thickens by equivalent to about 0.24V, and it is equivalent to decrease the background voltage by 16V.

From the above, the present invention is characterized by executing the correction of a line width based on the notion that the line width change amount when the background voltage is changed is equivalent to the line width change amount when the exposure light amount is changed.

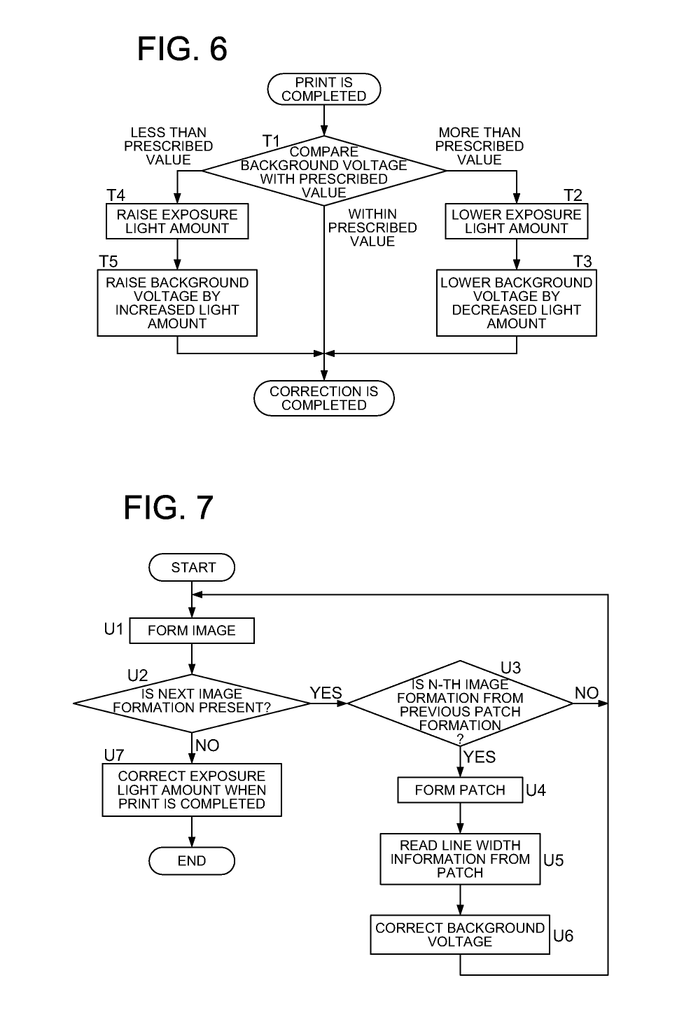

FIG. 6 illustrates a flowchart of a change in the background voltage or a light emitting amount of LPH at the point when the image forming process has been stopped.

In FIG. 6, when the background voltage correction amount is more than the prescribed value in STEP T1, the exposure light amount equivalent to the background voltage is lowered in STEP T2. In STEP 3, the background voltage is put back to C1, which is adjacent to the initial (when starting an image formation operation) background voltage B0 within a prescribed background voltage range. In case when the background voltage is less than the prescribed value in STEP 1, the exposing amount equivalent to the background voltage is raised in the STEP 4. In STEP 5, the background voltage is put back to C1, which is adjacent to the initial (when starting an image formation operation) background voltage B0 within a prescribed background voltage range.

FIG. 7 illustrates a flowchart of an operation process of the entire line width correction, to which the background voltage of every “n” prints and the light amount correction while the image forming process is in a stop state are combined.

In FIG. 77 image formation is conducted in STEP U1. In STEP U2, whether next image formation presents or not is checked. In case when YES in STEP U2, the image formation is continuously executed. In STEP U3, whether the current image formation is a n-th image formation from the previous toner patch formation. When NO in STEP U3, since the number of print has not reached to the n-th image formation, the next image formation is conducted. When YES in STEP U3, a toner patch is formed in STEP U4 (refer to FIG. 3). In STEP U5, the line width is read from the toner patch. In STEP US, the background voltage is corrected via a conversion program in the controller and the next image formation is conducted. When NO in STEP U2, namely, when the image formation is to be stopped, in STEP U7, the exposure light amount equivalent to the background voltage fluctuation amount at the time when starting the image formation operation is corrected via the conversion program (background voltage−exposure light amount) in the controller, and the background voltage is approached to the value of B0, which has been initially set (FIGS. 5(a)-5(b)).

In the above description, the method of the line width correction, which is conducted at the time when the continuous image formation stops, has been described. However, it is also possible to put back the background voltage described above to a C1, which is adjacent to the initially set background voltage B0 in every predetermined image formation operations, or periodical (in every number of prints “m”) timing in between sheets P.

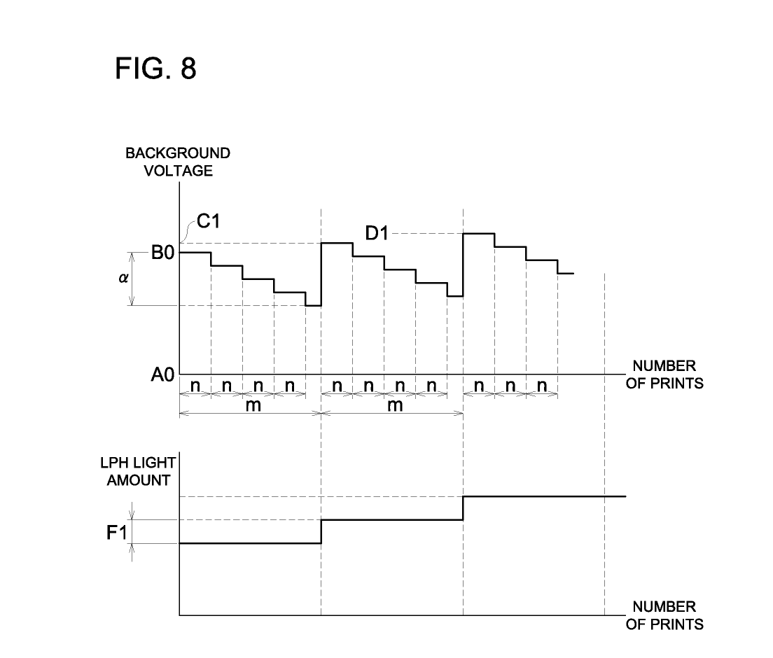

FIG. 8 is illustrated to explain the method to execute the background voltage correction and LPH light emitting amount correction in every image forming process of a predetermined number of prints.

In FIG. 8, the background voltage B0 of the initial setting in every “n” prints, the toner patch is formed between the sheets P and detected by the image sensor S. Only the background voltage is corrected as the same as described above.

Then, at the time when the number of prints has reached “m” prints, the background voltage is put back to the C1, which is adjacent to the background voltage B0, which has been initially set and is fluctuated by only the exposure light amount “F1”, which is equivalent to the fluctuation amount “α” from the initially set background voltage B0. Further, at the time when the number of next prints has reached to “m” prints, the background voltage is put back to the background voltage D1, which is adjacent to the background voltage BO, and the exposure light amount is also fluctuated.

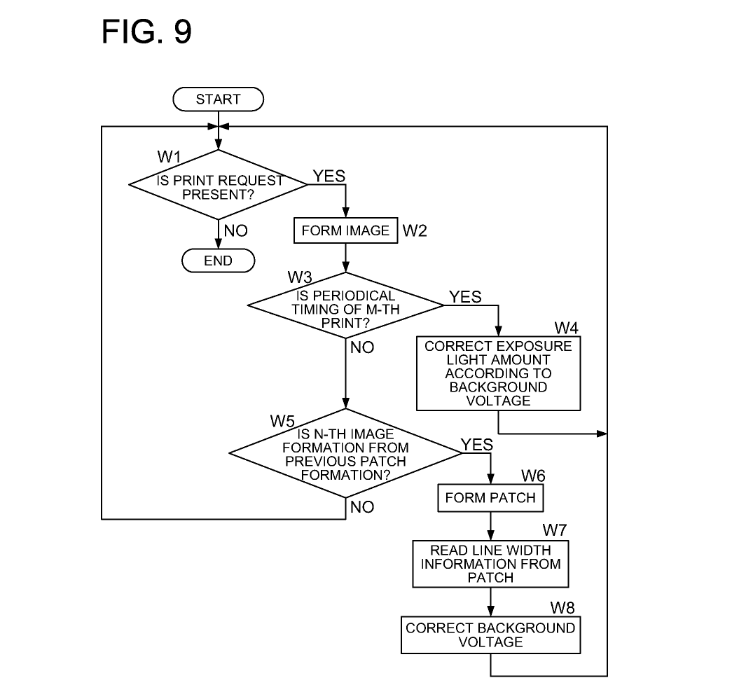

The process of the periodical line width correction described above will be explained based on the flowchart in FIG. 9.

FIG. 9 illustrates a flowchart of the process of the line width correction when the exposure light amount correction is executed at periodical timing.

In FIGS. 8 and 9, whether there was a print request or not is determined in STEP W1. In case when No in the STEP W1, it means to finish the image forming process. When Yes in STEP W1, an image forming is processed in STEP W2. In STEP W3, whether the image formation is “m-th” print image formation (which is plural times of “n” of the image forming process) or not is determined. When YES in STEP W3, the background voltage correction of “m-th” print is executed in STEP W4, and the exposure amount is corrected by an exposure light amount F1 equivalent to the fluctuation amount “α” from the initial background voltage B0. When NO in STEP W3, whether the image formation is “n-th” image formation from the toner patch formation is determined in STEP W5. When YES in STEP W5, the toner patch is formed in between sheets P in STEP W6 (refer to FIG. 3). In STEP W7, the line width is read from the toner patch. In STEP W8, the background voltage is corrected through a conversion program (line width−background voltage) in the controller and the process returns to STEP W1. When NO in STEP W5, the process returns to STEP W1.

What is claimed is:

1. An image forming apparatus comprising:
(a) a photoreceptor;
(b) a charging unit which charges the photoreceptor;
(c) an exposing unit which forms a latent image onto the photoreceptor;
(d) a developing unit which develops the latent image to a toner image;
(e) a sensor which detects a line width of a toner patch formed on the photoreceptor by the exposing unit and the developing unit; and
(f) a controller which changes a background voltage based on the line width detected by the sensor during an image forming operation so that the line width is secured within a predetermined line width,
wherein the controller returns the background voltage to value adjacent to an initial setting background voltage and changes the light amount of the exposing unit by a light amount corresponding to a returning amount of the background voltage.

2. The image forming apparatus of claim 1, wherein the background voltage is a difference between a voltage charged by the charging unit and a bias voltage to be applied to the developing unit.

3. The image forming apparatus of claim 1, wherein the controller returns the background voltage and changes the light amount of the exposing unit while stopping image forming operation.

4. The image forming apparatus of claim 3, wherein the controller returns the background voltage and changes the light amount of the exposing unit after a continuous print operation is completed.

5. The image forming apparatus of claim 1, wherein the controller returns the background voltage and changes the light amount of the exposing unit at a periodic timing.

6. The image forming apparatus of claim 5, wherein the controller returns the background voltage and changes the light amount of the exposing unit according to the number of prints at a periodic timing.

7. The image forming apparatus of claim 1, wherein the background voltage is changed successively during a continuous image forming operation.
